(19) United States
(12) Patent Application Publication
(10) Pub. No.: US 2011/0123762 A1
(43) Pub. Date: May 26, 2011

(54) BAMBOO STALK ASSEMBLY

(76) Inventor: Chien-I Chiang, Chia-Yi City (TW)

(21) Appl. No.: 12/622,757

(22) Filed: Nov. 20, 2009

(51) Int. Cl. B32B 7/00

(52) U.S. Cl. 428/119

(57) ABSTRACT

A bamboo assembly includes a first bamboo stalk with first and second holes. A second bamboo stalk extends through the first and second holes of the first bamboo stalk. The second bamboo stalk includes third and fourth holes. An insert is engaged in the third and fourth holes of the second bamboo stalk. An engaging member includes an engaging end extending through the first and second holes and engaged with the insert to engage the first and second bamboo stalks together.

### BACKGROUND OF THE INVENTION

The present invention relates to a bamboo stalk assembly and, more particularly, to a bamboo stalk assembly including two adjacent bamboo stalks securely engaged together.

Bamboos grow faster than trees and have a felling cycle of about 5 years while the felling cycle of trees is about 50 years or longer. Thus, bamboos can be obtained easier than trees. Furthermore, the bamboo stalks are hollow and light, and the nodes and straightness as well as tough fibers provide the stalks with bearing strength and tensile strength superior to wooden rods. Thus, the bamboos have become new green material for making furniture as well as for other use. FIG. 3 shows engagement of two bamboo stalks 2′ by an engaging member 1′ in the form of a nail or screw. However, the bamboo stalk 2′ cracks (see 21′) when the engaging member 1′ passes through the tough fiber of the bamboo stalk 2′. Furthermore, the hollow interior 22′ of the stalk 2′ provides no place for fixing a coupling end 11′ of the engaging member 1′. Currently, furniture manufacturers slice the bamboo stalks into pieces and then bond several of the pieces to form a bamboo rod. Two bamboo rods are drilled to form holes for engaging the bamboo rods through mortise and tenon joint. However, the rigidity of the bamboo stalks is destroyed, and the bamboo rods are liable to disengage from each other.

Thus, a need exists for a bamboo assembly allowing engagement of two stalks by an engaging member such as a nail or screw at low costs without sacrificing the original rigidity, bearing strength, and tensile strength.

### BRIEF SUMMARY OF THE INVENTION

The present invention solves this need and other problems in the field of engagement of bamboo stalks by providing, in a preferred form, a bamboo assembly including a first bamboo stalk with first and second holes. A second bamboo stalk extends through the first and second holes of the first bamboo stalk. The second bamboo stalk includes third and fourth holes. An insert is engaged in the third and fourth holes of the second bamboo stalk. An engaging member includes an engaging end extending through the first and second holes and engaged with the insert to engage the first and second bamboo stalks together.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a partial, side view of a bamboo assembly according to the preferred teachings of the present invention.

FIG. 2 shows a partial, cross sectional view of the bamboo assembly of FIG. 1 according to section line 2-2 of FIG. 1.

FIG. 3 shows a partial, perspective view of a conventional bamboo assembly.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

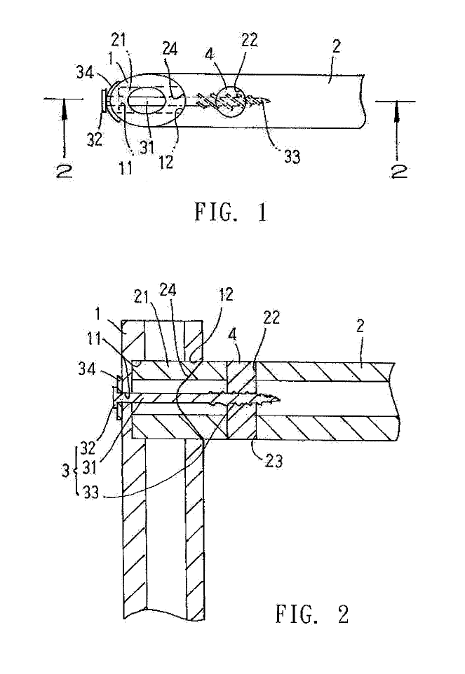

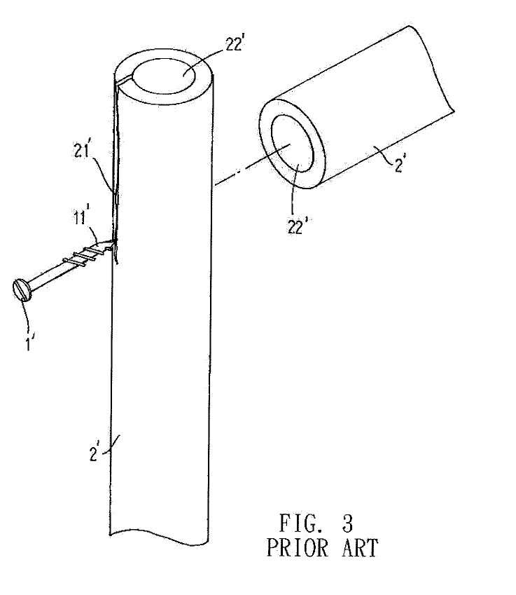

A bamboo assembly according to the preferred teachings of the present invention is shown in FIGS. 1 and 2 and generally includes first and second bamboo stalks 1 and 2, an engaging member 3, and an insert 4.

The first bamboo stalk 1 includes first and second holes 11 and 12 formed by drilling The first and second holes 11 and 12 are formed in two aligned portions of a stalk body of the first bamboo stalk 1 and allow passage of the engaging member 3 in the form of a nail or screw. In order to securely engage first and second bamboo stalks 1 and 2 together, the second hole 12 can be further processed to be larger than a coupling end 21 of the second bamboo stalk 2, such that the coupling end 21 of the second bamboo stalk 2 can extend through and be supported by a periphery of the second hole 12.

The second bamboo stalk 2 includes two holes 22 and 23 formed by drilling. The holes 22 and 23 are formed in two aligned portions of a stalk body of the second bamboo stalk 2. In order to securely engage first and second bamboo stalks 1 and 2 together, each of two sides of the coupling end 21 of the second bamboo stalk 2 includes a recessed portion 24 in intimate contact with the stalk body of the first bamboo stalk 1.

The engaging member 3 is in the form of a nail or screw and includes a stem 31 having a head 32 on an end of the stem 31 and an engaging end 33 on the other end of the stem 31. The engaging end 33 is pointed and may include threading to allow easy penetration and fixing. The diameter of the head 32 is larger than the first hole 11. The engaging end 33 is engaged with the insert 4 to secure the first and second bamboo stalks 1 and 2 together. In order to distribute the force imparted from the head 32 to an area surrounding the first hole 11, a washer 34 can be mounted around the stem 31 between the head 32 and the first hole 11.

The insert 4 is made of wood, plastic, etc. The diameter of the insert 4 is the same as the holes 21 and 22 of the second bamboo stalk 4, such that two ends of the insert 4 can be tightly engaged in the holes 21 and 22 with an intermediate portion of the insert 4 located in an interior of the second bamboo stalk 2. The engaging end 33 of the engaging member 3 is fixed to the intermediate portion of the insert 4.

With reference to FIG. 2, due to hollow interiors of the first and second bamboo stalks 1 and 2, the engaging member 3 can extend through the first and second holes 11 into the hollow interior of the second bamboo stalk 2 to engage with the intermediate portion of the insert 4 fixed in the holes 21 and 22. Since the insert 4 does not have to be processed to include holes with inner threading, the engagement between the insert 4 and the engaging member 3 is easy. Furthermore, the engagement between the insert 4 and the engaging member 3 is as reliable as two wooden rods fixed together by a nail or screw. Further, the structure according to the preferred teachings of the present invention is simple and allows mass production at low costs without waste of material and without destroying the original rigidity, bearing strength, and tensile strength of the first and second bamboo stalks 1 and 2.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A bamboo assembly comprising:
a first bamboo stalk including a first hole and a second hole;
a second bamboo stalk extending through the first and second holes of the first bamboo stalk, with the second bamboo stalk including third and fourth holes;
an insert engaged in the third and fourth holes of the second bamboo stalk; and
an engaging member including an engaging end extending through the first and second holes and engaged with the insert to engage the first and second bamboo stalks together.

2. The bamboo assembly as claimed in claim 1, with the engaging member being a screw including a stem having two ends, with a head formed on one of the two ends of the stem, with the engaging end formed on the other end of the stem, with the head having a diameter larger than that of the first hole, and with a washer mounted around the stem between the head and the first hole of the first stalk.

3. The bamboo assembly as claimed in claim 2, with the second bamboo stalk including a coupling end extending through the first and second holes of the first bamboo stalk, with the second hole having a diameter larger than that of the coupling end of the second bamboo stalk, and with the coupling end of the second bamboo stalk extending through and supported by a periphery of the second hole of the first bamboo stalk.

4. The bamboo assembly as claimed in claim 3, the coupling end of the second bamboo stalk having two sides, with each of the two sides of the coupling end of the second bamboo stalk including a recessed portion in intimate contact with a stalk body of the first bamboo stalk.

5. The bamboo assembly as claimed in claim 1, with the engaging member being a nail including a stem having two ends, with a head formed on one of the two ends of the stem, with the engaging end formed on the other end of the stem, with the head having a diameter larger than that of the first hole, and with a washer mounted around the stem between the head and the first hole of the first stalk.

6. The bamboo assembly as claimed in claim 5, with the second bamboo stalk including a coupling end extending through the first and second holes of the first bamboo stalk, with the second hole having a diameter larger than that of the coupling end of the second bamboo stalk, and with the coupling end of the second bamboo stalk extending through and supported by a periphery of the second hole of the first bamboo stalk.

7. The bamboo assembly as claimed in claim 6, the coupling end of the second bamboo stalk having two sides, with each of the two sides of the coupling end of the second bamboo stalk including a recessed portion in intimate contact with a stalk body of the first bamboo stalk.
